(19) United States
(12) Patent Application Publication
(10) Pub. No.: US 2025/0320044 A1
(43) Pub. Date: Oct. 16, 2025

(54) SINGLE USE CONTAINERS AND METHODS OF MANUFACTURING

(71) Applicant: Cambio Roasters, LLC, Isle of Palms, SC (US)

(72) Inventors: Richard Estabrook, Shelburne, VT (US); Kevin Hartley, Isle of Palms, SC (US)

(73) Assignee: Cambio Roasters, LLC, Isle of Palms, SC (US)

(21) Appl. No.: 18/634,607

(22) Filed: Apr. 12, 2024

Related U.S. Application Data
(60) Provisional application No. 63/468,819, filed on May 25, 2023.

(51) Int. Cl. B65D 65/40; B29C 51/08; B29C 51/14; B29K 23/00; B29L 31/00; B32B 15/085; B32B 15/20; B32B 27/32; B65D 65/42; B65D 85/804

(52) U.S. Cl. CPC B65D 65/40; B32B 15/085; B32B 15/20; B32B 27/32; B65D 65/42; B65D 85/8043; B29C 51/08; B29C 51/14; B29K 2023/12; B29L 2031/7174; B32B 2255/06; B32B 2255/28; B32B 2307/31; B32B 2307/7376; B32B 2439/40

(57) ABSTRACT

Described herein are food containers and methods of manufacturing food containers. A food container may include a single-use coffee pod including a multi-layer sheet comprising a rim with a flat top surface, a stacking lip positioned below the rim, an inward tapering sidewall with a draft angle of at least 0.5 degrees and at most 10 degrees positioned below the stacking lip, and a bottom surface; wherein the multi-layer sheet comprises, from outside to inside, a first lubricant layer, an aluminum layer, and a coextrusion coating; and wherein the single-use coffee pod has a depth to diameter ratio of more than 0.5:1.

### FIELD OF THE INVENTION

The present invention generally relates to the field of beverage containers. In particular, the present invention is directed to single use coffee pods and methods of manufacturing.

### BACKGROUND

Beverages such as coffee and tea are being increasingly prepared using single serve brewing capsules. Many product benefits are realized when using such capsules versus multi-serve bulk packaged roast and ground coffee. Capsules offer individual choice, wide availability of variety, fresh-brewed flavor, and preparation convenience. Additionally, ecological benefits are realized when using single serve brewing capsules versus bulk-packaged roast and ground coffee; most importantly, less waste of the coffee itself. First, unlike a pot of coffee which often does not get fully consumed, it is reasonable to expect that beverages prepared using single serve capsules are more likely to be fully consumed versus a pot of coffee which may either not get totally consumed due to either too much being brewed or development of off-taste. And second, unlike a large multi-serve container of coffee which can go stale after opening and before being fully consumed, single serve brewing capsules are usually protected from oxygen degradation by aluminum barrier packaging and each one remains fresh until brewed, thus avoiding discarding old off-flavor roast and ground coffee. Both of these single serve brewing capsules benefits help the ecosystem by avoiding waste of the valuable coffee crop itself which includes all of the beneficial effects of reducing wasted agricultural activity. However, in spite of their popularity, single serve brewing capsules made from plastic, have been widely criticized for several specific reductions in eco-friendliness versus, say, a multi-serve container of loose roast and ground coffee. First, the individual packaging of each single serve capsule leads to the use of more packaging materials per coffee serving. Second, individual packaging of the roast and ground coffee is not as space efficient as bulk coffee, reducing efficiency in distribution to stores. Third, recycling of capsules can be difficult. For example, some capsules have a foil lid and a plastic cup. The two components must be separated so that the foil does not contaminate the plastic recycling stream into which the cup would intend to be introduced into. So, for example, it is helpful to consumers to have a pull tab on the foil lid and to affix the lid to the cup in a peel-able fashion. However, another less obvious problem in recycling of capsules is that they are too small for recycling centers to efficiently reclaim.

Single serve brewing capsules entered onto the world market in the early 1990's. The overall number of capsules is likely approaching 20 to 30 billion units. Thus, a long felt need exists to improve the eco-friendliness of the overall packaging system for single serve brewing capsules, including reducing the amount of single-use plastic packaging, and improving the recyclability.

### SUMMARY OF THE DISCLOSURE

In an aspect, a single-use container may include a multi-layer sheet including a rim with a flat top surface; a stacking lip positioned below the rim; an inward tapering sidewall with a draft angle of at least 0.5 degrees and at most 10 degrees positioned below the stacking lip; and a bottom surface; wherein the multi-layer sheet comprises, from outside to inside, a first lubricant layer, an aluminum layer, and a coextrusion coating; and wherein the single-use container has a depth to diameter ratio of at least 0.5:1, with depth measured from the flat top surface of the rim to the bottom surface along a central axis of the single-use container, and diameter measured across the exterior of the rim.

In another aspect, a method of manufacturing a single-use container may include providing a multi-layer sheet comprising, from a first side to a second side, a first lubricant layer, an aluminum layer, and a coextrusion coating; and deep drawing the multi-layer sheet to form a single-use coffee pod comprising a rim with a flat top surface, a stacking lip positioned below the rim, an inward tapering sidewall with a draft angle of at least 0.5 degree and at most 10 degrees positioned below the stacking lip, and a bottom surface such that the first side is on the outside and the second side is on the inside; wherein the single-use container has a depth to diameter ratio of more than 0.5:1, with depth measured from the flat top surface of the rim to the bottom surface along a central axis of the single-use container, and diameter measured across the exterior of the rim.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an illustration of a side view of an exemplary embodiment of a food container;

FIG. 2 is an illustration of a top view of an exemplary embodiment of a food container;

FIG. 3 is an illustration of a side view of an exemplary embodiment of a portion of a plurality of food containers;

FIG. 4 is an illustration of a side view of an exemplary embodiment of a multi-layer sheet;

FIG. 5 is a flow diagram depicting an exemplary embodiment of a method of manufacturing a food container; and

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to food containers, such as single-use coffee pods. Also described herein are methods of manufacturing food containers such as single-use coffee pods. A food container may include an aluminum capsule suitable for use in low-pressure beverage-making appliances. A food container may be constructed from a laminated barrier material using a press forming or stamping process such as a deep draw process.

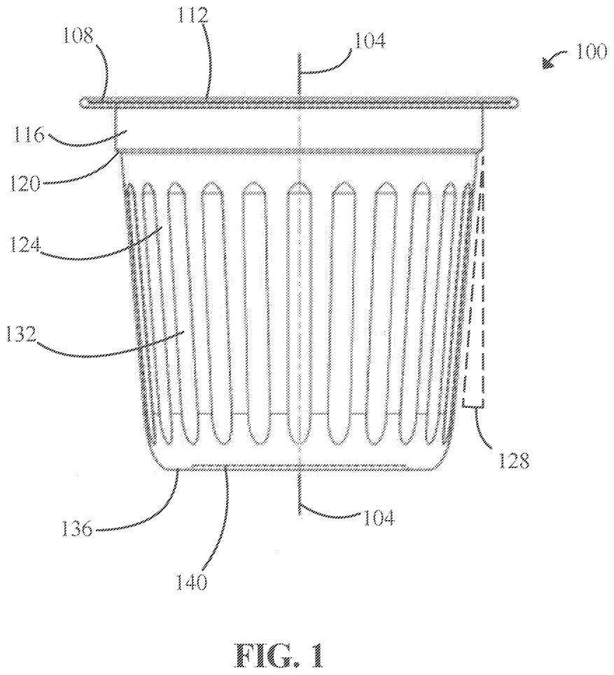

Referring now to FIG. 1, a side view of an exemplary embodiment of a single-use container 100 is provided. Single-use container 100 includes a food container. In some embodiments, a food container may include a coffee pod. In some embodiments, a coffee pod may include a single-use coffee pod. As used herein, a “food container” is an object which holds food. As used herein, a “coffee pod” is a food container which holds a product made from coffee beans, a product including coffee beans, or both. As used herein, a food container is a “single-use” food container if the food container is not designed to be re-sealed once opened without external devices or replacement parts. For example, a jar with a screw-on lid in which the lid may be freely screwed off and on is not a single-use food container. In another example, a food container with a lid sealed to the food container using an adhesive in which the lid, once removed, cannot be re-applied is a single-use food container. In another example, a food container with a lid which is designed to be opened by tearing or puncturing the food container or lid such that the food container cannot be re-sealed using the same parts is a single-use food container.

Still referring to FIG. 1, in some embodiments, single-use container 100 includes a food container made using a multi-layer sheet. Multi-layer sheet may include a multi-layer laminate sheet. Multi-layer sheet may include primarily aluminum and/or polypropylene. In some embodiments, multi-layer sheet includes a first side and a second side. Single-use container 100 may be manufactured such that first side is on the outside of single-use container 100 and second side is on the inside of single-use container 100. As described below, second side may also make up a top surface of a food container onto which a lid is attached. In some embodiments, a multi-layer sheet includes, from first side to second side, first lubricant layer, varnish layer, printing ink layer, primer layer, aluminum layer, coextrusion coating, and second lubricant layer.

Still referring to FIG. 1, in some embodiments, single-use container 100 may be made using a multi-layer sheet including a first lubricant layer. First lubricant layer may be positioned on the outside of single-use container 100. As used herein, a “lubricant layer” is a layer whose presence reduces friction, adhesion, or both, between two materials which would otherwise be adjacent. In some embodiments, a lubricant layer has a silicone base. In some embodiments, a lubricant layer may make up about 0.1% of a multilayer sheet by weight. In some embodiments, a lubricant layer in a finished food container may weigh about 0.002 g. In some embodiments, a lubricant layer may make up about 0.2% of a multilayer sheet by weight. In some embodiments, a lubricant layer in a finished food container may weigh about 0.004 g. In some embodiments, a multi-layer sheet may include a first lubricant layer on a first side and a second lubricant layer on a second side. In some embodiments, a plurality of lubricant layers may make up about 0.2% of a multilayer sheet by weight. In some embodiments, a plurality of lubricant layers in a finished food container may weigh about 0.004 g. In some embodiments, inclusion of a lubricant layer may aid in a deep drawing process, such as by making it easier to take single-use container 100 out of a deep drawing machine. In some embodiments, one or both lubricant layers may have a weight per area of multi-layer sheet of 0.55±0.15 g/m².

Still referring to FIG. 1, in some embodiments, single-use container 100 may include a varnish layer. As used herein, a “varnish layer” is a material which is at least partially transparent. In some embodiments, a varnish layer may be positioned immediately inside of first lubricant layer. For example, a varnish layer may be positioned between the first lubricant layer and the center of single-use container 100 in a finished single-use container. In some embodiments, a varnish layer may have a polyurethane base. In some embodiments, a varnish layer may make up about 0.72% of multilayer sheet by weight. In some embodiments, a varnish layer in a finished food container may weigh about 0.015 g. In some embodiments, varnish layer may have a weight per area of multi-layer sheet of 2±0.5 g/m².

Still referring to FIG. 1, in some embodiments, single-use container 100 may include a printing ink layer. As used herein, a “printing ink layer” is a material which is at least partially non-transparent. In some embodiments, a printing ink layer may be positioned immediately inside of varnish layer. For example, a printing ink layer may be positioned between the varnish layer and the center of single-use container 100 in a finished single-use container. In some embodiments, a printing ink layer may have a polyvinyl butyral base. In some embodiments, a varnish layer may have negligible weight in comparison to other components of a multi-layer sheet.

Still referring to FIG. 1, in some embodiments, single-use container 100 may include a primer layer. As used herein, a “primer layer” is a material onto which a printing ink layer is applied. In some embodiments, a primer layer may be positioned immediately inside of printing ink layer. For example, a primer layer may be positioned between the printing ink layer and the center of single-use container 100 in a finished single-use container. In some embodiments, a primer layer may have an acrylate base. In some embodiments, a primer layer may have a polyester base. In some embodiments, a primer layer may make up about 0.72% of multilayer sheet by weight. In some embodiments, a varnish layer in a finished food container may weigh about 0.015 g. In some embodiments, primer layer may have a weight per area of multi-layer sheet of 2±0.5 g/m².

Still referring to FIG. 1, in some embodiments, single-use container 100 includes an aluminum layer. As used herein, an “aluminum layer” is a material that includes aluminum, an aluminum alloy, or both. In some embodiments, an aluminum layer may be positioned immediately inside of primer layer. For example, an aluminum layer may be positioned between the primer layer and the center of single-use container 100 in a finished single-use container. An aluminum layer may be made from recycled aluminum and/or aluminum alloy, virgin aluminum and/or aluminum alloy, or a combination thereof. In some embodiments, an aluminum layer may have a thickness of 90 μm±8%. In some embodiments, an aluminum layer may have a thickness of 82.8 μm to 97.2 μm. In some embodiments, an aluminum layer may make up about 87.59% of multilayer sheet by weight. In some embodiments, an aluminum layer in a finished food container may weigh about 1.816 g. In some embodiments, aluminum layer may have a weight per area of multi-layer sheet of 243.9±20 g/m².

Still referring to FIG. 1, in some embodiments, aluminum layer may include an aluminum alloy such as Aluminum 3004-H19. In some embodiments, an aluminum layer may include 95.5%-98.2% aluminum, ≤0.25% copper, ≤0.70% iron, 0.80%-1.3% magnesium, 1.0%-1.5% manganese, ≤0.3% silicon, ≤0.25% zinc, and ≤0.15% other (with each element of the “other” category being≤0.05%).

Still referring to FIG. 1, in some embodiments, aluminum layer may include one or more properties described in Table 1.

TABLE 1

| Property | Metric | | English | | Comments |
|---|---|---|---|---|---|
| Density | 2.72 | g/cc | .0983 | lb/in³ | AA; typical |
| Hardness, Brinell | 79 | | 79 | | 500 kg load with 10 |
| | | | | | mm ball. Calculated |
| | | | | | value. |
| Hardness, Knoop | 102 | | 102 | | Converted from |
| | | | | | Brinell hardness |
| | | | | | value. |
| Hardness, Vickers | 89 | | 89 | | Converted from |
| | | | | | Brinell hardness |
| | | | | | value. |
| Tensile Strength, | 295 | MPa | 42800 | psi | |
| Ultimate | | | | | |
| Tensile Strength, | 285 | MPa | 41300 | psi | |
| Yield | | | | | |
| Elongation at Break | 2.0% @ thickness | | 2.0% @ thickness | | In 5 cm |
| | 1.60 mm | | .0630 in | | |
| Modulus of Elasticity | 69.0 | GPa | 10000 | ksi | Average of Tension |
| | | | | | and Compression. In |
| | | | | | Al alloys, the |
| | | | | | compressive modulus |
| | | | | | is typically 2% |
| | | | | | greater than the |
| | | | | | tensile modulus |
| Poissons Ratio | .35 | | .35 | | |
| Shear Modulus | 25.0 | GPa | 3630 | ksi | |
| Shear Strength | 180 | MPa | 26100 | psi | Calculated value. |
| Electrical Resistivity | .00000416 ohm-cm @ | | .00000416 ohm-cm @ | | AA; typical |
| | Temperature 20.0° C. | | Temperature 68.0° F. | | |
| Magnetic | 8.0e−7 | | 8.0e−7 | | cgs/g at 25.0° C. |
| Susceptibility | | | | | |
| CTE, linear | 21.5 μm/m-° C. @ | | 11.9 μin/in-° F. @ | | AA; typical; average |
| | Temperature −50.0- | | Temperature −58.0- | | over time |
| | 20.0° C. | | 68.0° F. | | |
| | 23.2 μm/m-° C. @ | | 12.9 μin/in-° F. @ | | |
| | Temperature 20.0- | | Temperature 68.0- | | |
| | 100.0° C. | | 212° F. | | |
| | 23.9 μm/m-° C. @ | | 13.3 μin/in-° F. @ | | |
| | Temperature 20.0- | | Temperature 68.0- | | |
| | 100° C. | | 212° F. | | |
| | 24.1 μm/m-° C. @ | | 13.4 μin/in-° F. @ | | |
| | Temperature 20.0 | | Temperature 68.0- | | |
| | 200° C. | | 392° F. | | |
| | 25.1 μm/m-° C. @ | | 13.9 μin/in-° F. @ | | |
| | Temperature 20.0- | | Temperature 68.0- | | |
| | 300° C. | | 572° F. | | |
| Specific Heat | .893 | J/g-°C. | .213 | BTU/lb-°F. | |
| Capacity | | | | | |
| Thermal | 163 | W/m-K | 1130 BTU-in/ | | AA; typical at 77° F. |
| Conductivity | | | hr-ft²-°F. | | |
| Melting Point | 629.4-654° | C. | 1165-1210° | F. | AA; typical range |
| | | | | | based on typical |
| | | | | | composition for |
| | | | | | wrought products ≥¼ |
| | | | | | in. thickness |
| Solidus | 629.4° | C. | 1165° | F. | AA; typical |
| Liquidus | 654° | C. | 1210° | F. | AA; typical |
| Annealing | 413° | C. | 775° | F. | |
| Temperature | | | | | |

Still referring to FIG. 1, in some embodiments, single-use container 100 includes a coextrusion coating. As used herein, a “coextrusion coating” is a material which contains a plurality of polymer types. In some embodiments, a coextrusion coating may be positioned immediately inside of an aluminum layer. For example, a coextrusion coating may be positioned between the aluminum layer and the center of single-use container 100 in a finished single-use container. In some embodiments, a coextrusion coating may include a tie layer and/or a heat seal layer. As used herein, a “tie layer” is an adhesive material. For example, a tie layer may provide adhesion between 2 layers which would normally not adhere to each other. In some embodiments, a tie layer may include a polypropylene base. As used herein, a “heat seal layer” is a material which conducts heat poorly. In some embodiments, a heat seal layer may include a polypropylene base. In some embodiments, a coextrusion coating may include a mix of a tie layer and a heat seal layer, such that they do not make up distinct layers. In some embodiments, a coextrusion coating may include a tie layer and a heat seal layer which are distinct. In some embodiments, a coextrusion coating may make up about 10.77% of multilayer sheet by weight. In some embodiments, a coextrusion coating in a finished food container may weigh about 0.223 g. In some embodiments, coextrusion coating may have a weight per area of multi-layer sheet of 30±3 g/m².

Still referring to FIG. 1, in some embodiments, single-use container 100 may include a second lubricant layer. Second lubricant layer may be an innermost layer of single-use container 100. For example, second heat seal layer may be positioned between coextrusion coating and the interior of single-use coffee pod. Second lubricant layer may include one or more features described above with respect to first lubricant layer.

Still referring to FIG. 1, in some embodiments, single-use container 100 may have a total mass of 2.074 g. In some embodiments, multi-layer sheet has a mass per area of 278.45 g/m².

Still referring to FIG. 1, manufacturing and/or forming of a part, workpiece, or other object may be performed, without limitation, using a manufacturing device. A manufacturing device may include an additive manufacturing devices may include without limitation any device designed or configured to produce a component, product, or the like using an additive manufacturing process, in which material is deposited on the workpiece to be turned into the finished result. In some embodiments, an additive manufacturing process is a process in which material is added incrementally to a body of material in a series of two or more successive steps. The material may be added in the form of a stack of incremental layers; each layer may represent a cross-section of the object to be formed upon completion of the additive manufacturing process. Each cross-section may, as a non-limiting example be modeled on a computing device as a cross-section of graphical representation of the object to be formed; for instance, a computer aided design (CAD) tool may be used to receive or generate a three-dimensional model of the object to be formed, and a computerized process may derive from that model a series of cross-sectional layers that, when deposited during the additive manufacturing process, together will form the object. The steps performed by an additive manufacturing system to deposit each layer may be guided by a computer aided manufacturing (CAM) tool. In other embodiments, a series of layers are deposited in a substantially radial form, for instance by adding a succession of coatings to the workpiece. Similarly, the material may be added in volumetric increments other than layers, such as by depositing physical voxels in rectilinear or other forms. Additive manufacturing, as used in this disclosure, may specifically include manufacturing done at the atomic and nano level. Additive manufacturing also includes bodies of material that are a hybrid of other types of manufacturing processes, e.g. forging and additive manufacturing as described above. As an example, a forged body of material may have welded material deposited upon it which then comprises an additive manufactured body of material.

Still referring to FIG. 1, deposition of material in additive manufacturing processes may be accomplished by any suitable means. Deposition may be accomplished using stereolithography, in which successive layers of polymer material are deposited and then caused to bind with previous layers using a curing process such as curing using ultraviolet light. Additive manufacturing processes may include “three-dimensional printing” processes that deposit successive layers of power and binder; the powder may include polymer or ceramic powder, and the binder may cause the powder to adhere, fuse, or otherwise join into a layer of material making up the body of material or product. Additive manufacturing may include metal three-dimensional printing techniques such as laser sintering including direct metal laser sintering (DMLS) or laser powder-bed fusion. Likewise, additive manufacturing may be accomplished by immersion in a solution that deposits layers of material on the body of material, by depositing and sintering materials having melting points such as metals, such as selective laser sintering, by applying fluid or paste-like materials in strips or sheets and then curing that material either by cooling, ultraviolet curing, and the like, any combination of the above methods, or any additional methods that involve depositing successive layers or other increments of material. Methods of additive manufacturing may include without limitation vat polymerization, material jetting, binder jetting, material extrusion, fuse deposition modeling, powder bed fusion, sheet lamination, and directed energy deposition. Methods of additive manufacturing may include adding material in increments of individual atoms, molecules, or other particles. An additive manufacturing process may use a single method of additive manufacturing, or combine two or more methods.

Still referring to FIG. 1, additive manufacturing may include deposition of initial layers on a substrate. Substrate may include, without limitation, a support surface of an additive manufacturing device, or a removable item placed thereon. Substrate may include a base plate, which may be constructed of any suitable material; in some embodiments, where metal additive manufacturing is used, base plate may be constructed of metal, such as titanium. Base plate may be removable. One or more support features may also be used to support additively manufactured body of material during additive manufacture; for instance and without limitation, where a downward-facing surface of additively manufactured body of material is constructed having less than a threshold angle of steepness, support structures may be necessary to support the downward-facing surface; threshold angle may be, for instance 45 degrees. Support structures may be additively constructed, and may be supported on support surface and/or on upward-facing surfaces of additively manufactured body of material. Support structures may have any suitable form, including struts, buttresses, mesh, honeycomb or the like; persons skilled in the art, upon reviewing the entirety of this disclosure, will be aware of various forms that support structures may take consistently with the described methods and systems.

Still referring to FIG. 1, an additive manufacturing device may include an applicator or other additive device. For instance, an additive manufacturing device may include a printer head for a 3D printer. An additive manufacturing device may include an extruding device for extruding fluid or paste material, a sprayer or other applicator for bonding material, an applicator for powering, a sintering device such as a laser, or other such material.

Still referring to FIG. 1, an additive manufacturing device may include one or more robotic elements, including without limitation robot arms for moving, rotating, or otherwise positioning a workpiece, or for positioning a manufacturing tool, printer heads, or the like to work on workpiece. An additive manufacturing device may include one or more workpiece transport elements for moving a workpiece or finished part or component from one manufacturing stage to another; workpiece transport elements may include conveyors such as screw conveyors or conveyor belts, hoppers, rollers, or other items for moving an object from one place to another.

Still referring to FIG. 1, manufacturing device may include a subtractive manufacturing device, which may perform one or more subtractive manufacturing processes. One or more steps may include a subtractive manufacturing process, which produces the product by removing material from a workpiece; the removal of material may be accomplished using abrasives, cutting tools or endmills, laser cutting or ablation, removal using heat, or any other method that removes material from the workpiece. Each subtractive manufacturing process used may be any suitable process, such as, but not limited to, rotary-tool milling, electronic discharge machining, ablation, etching, erosion, cutting, sawing, sanding, polishing, grinding, and cleaving, among others.

Still referring to FIG. 1, if rotary-tool milling is utilized, this milling may be accomplished using any suitable type of milling equipment, such as milling equipment having either a vertically or horizontally oriented spindle shaft. Examples of milling equipment include bed mills, turret mills, C-frame mills, floor mills, gantry mills, knee mills, and ram-type mills, among others. In some embodiments, the milling equipment used for removing material may be of the computerized numerical control (CNC) type that is automated and operates by precisely programmed commands that control movement of one or more parts of the equipment to effect the material removal. CNC machines, their operation, programming, and relation to CAM tools and CAD tools are well known and need not be described in detail herein for those skilled in the art to understand the scope of the present invention and how to practice it in any of its widely varying forms.

Still referring to FIG. 1, subtractive manufacturing may be performed using spark-erosive devices; for instance, subtractive manufacturing may include removal of material using electronic discharge machining (EDM). EDM may include wire EDM, plunge EDM, immersive EDM, ram EDM, or any other EDM manufacturing technique. Subtractive manufacturing may be performed using laser-cutting processes. Subtractive manufacturing may be performed using water-jet or other fluid-jet cutting techniques. Fundamentally, any process for removal of material may be employed for subtractive manufacturing.

Still referring to FIG. 1, a manufacturing process may include a formative manufacturing process. In some embodiments, a formative manufacturing process may change a shape and/or configuration of a material. In some embodiments, a formative manufacturing process does not add or subtract to a material. In some embodiments, single-use container 100 may be manufactured using a deep drawing process. Deep drawing is a process used for manufacturing products from sheets of material, such as multi-layer sheet as described herein. In deep drawing, a sheet is radially drawn into a die cavity by the mechanical action of a punch. A shape of a deep drawn object may be determined at least in part by a shape of a die and a punch. For example, a punch with a desired shape of an interior of single-use container 100 may be used. In some embodiments, a deep drawing process is not additive or subtractive. In some embodiments, a die holder may be used to reduce or remove compressive stress in a multi-layer sheet during deep drawing. In some embodiments, deep drawing may be used in combination with one or more other material forming techniques such as beading, bottom piercing, bulging, coining, curling, extruding, wall thinning, necking, notching, rib forming, side piercing, stamping, threading, and/or trimming. In a non-limiting example, multi-layer sheet may be first deep drawn then rib forming and trimming processes may be performed to create a single use container. In some embodiments, deep drawing of multi-layer sheet as described herein may allow for successful stretching and forming of material into containers without tearing or deforming them. In some embodiments, a manufacturing device such as a deep-drawing press-forming equipment may include an electronic programmable logic controller (PLC) which can synchronize and adjust each critical function step within the machine. In non-limiting examples, pressure applied by a punch and/or relative position of punch and material of a multi-layer sheet may be set and/or adjusted by PLC. Using this PLC, deep drawing may be used to produce single-use container 100 as described herein.

Still referring to FIG. 1, in some embodiments, a manufacturing process may include a cold working process. A cold working process may include a process which includes manipulating metal below its recrystallization temperature. In some embodiments, a cold working process may include manipulating metal at ambient temperature. A cold working process may include, in non-limiting examples, squeezing, bending, drawing, and/or shearing of metal. In some embodiments, a cold working process may have the advantage of being simpler than alternative processes. In some embodiments, a manufacturing process may include a sheet metal forming process. Sheet metal forming may include applying force to sheet metal such that it is plastically deformed into a desired shape, without adding or removing material.

Still referring to FIG. 1, manufacturing device may include a mechanical manufacturing device. In an embodiment, mechanical manufacturing device may be a manufacturing device that deprives the user of some direct control over the toolpath, defined as movements the manufacturing tool and workpiece make relative to one another during the one or more manufacturing steps. For instance, manufacturing tool may be constrained to move vertically, by a linear slide or similar device, so that the only decision the user may make is to raise or lower the manufacturing tool; as a non-limiting example, where manufacturing device is a manually operated machine tool, user may only be able to raise and lower a cutting tool, and have no ability to move the cutting tool horizontally. Similarly, where manufacturing tool includes a slide lathe, a blade on the slide lathe may be constrained to follow a particular path. As a further example, base table may be moveable along one or more linear axes; for instance, base table may be constrained to move along a single horizontal axis. In other embodiments, base table is constrained to movement along two horizontal axes that span two dimensions, permitting freedom of movement only in a horizontal plane; for instance, base table may be mounted on two mutually orthogonal linear slides.

Still referring to FIG. 1, manufacturing device may include a powered manufacturing device. In an embodiment, a powered manufacturing device may be a manufacturing device in which at least one component of the manufacturing device includes at least a component powered by something other than human power. At least a component may be powered by any non-human source, including without limitation electric power generated or stored by any means, heat engines including steam, internal combustion, or diesel engines, wind power, water power, pneumatic power, or hydraulic power. Powered components may include any components of manufacturing device. Manufacturing tool may be powered; for instance, manufacturing tool may include an endmill mounted on a spindle rotated by a motor (not shown). Workpiece support may be powered. Where manufacturing device is a mechanical device, motion of components along linear or rotary constraints may be powered; for instance, motion of base table along one or more linear constraints such as linear slides may be driven by a motor or other source of power. Similarly, rotation of a table may be driven by a power source. Tool-changer, where present, may be driven by power. In some embodiments, all or substantially all of the components of manufacturing device are powered by something other than human power; for instance, all components may be powered by electrical power.

Still referring to FIG. 1, manufacturing device may include an automated manufacturing system. In some embodiments, an automated manufacturing system is a manufacturing device including a controller that controls one or more manufacturing steps automatically. Controller may include a sequential control device that produces a sequence of commands without feedback from other components of automated manufacturing system. Controller may include a feedback control device that produces commands triggered or modified by feedback from other components. Controller may perform both sequential and feedback control. In some embodiments, controller includes a mechanical device. In other embodiments, controller includes an electronic device. Electronic device may include digital or analog electronic components, including without limitation one or more logic circuits, such one or more logic gates, programmable elements such as field-programmable arrays, multiplexors, one or more operational amplifiers, one or more diodes, one or more transistors, one or more comparators, and one or more integrators. Electronic device may include a processor. Electronic device may include a computing device. Computing device may include any computing device as described below. Computing device may include a computing device embedded in manufacturing device; as a non-limiting example, computing device may include a microcontroller, which may be housed in a unit that combines the other components of manufacturing device. Controller may include a manufacturer client of plurality of manufacturer clients; controller may be communicatively coupled to a manufacturer client of plurality of manufacturer clients.

Still referring to FIG. 1, controller may include a component embedded in manufacturing device; as a non-limiting example, controller may include a microcontroller, which may be housed in a unit that combines the other components of manufacturing device. Further continuing the example, microcontroller may have program memory, which may enable microcontroller to load a program that directs manufacturing device to perform an automated manufacturing process. Similarly, controller may include any other components of a computing device as described below in a device housed within manufacturing device. In other embodiments, controller includes a computing device that is separate from the rest of the components of manufacturing device; for instance, controller may include a personal computer, laptop, or workstation connected to the remainder of manufacturing device by a wired or wireless data connection. In some embodiments, controller includes both a personal computing device where a user may enter instructions to generate a program for turning workpiece into a finished product, and an embedded device that receives the program from the personal computing device and executes the program. Persons skilled in the art will be aware of various ways that a controller, which may include one or more computing devices, may be connected to or incorporated in an automated manufacturing system as described above.

Still referring to FIG. 1, controller may control components of automated manufacturing system; for instance, controller may control elements including without limitation tool changer to switch endmills, spindle or gear systems operatively coupled to spindle to regulate spindle rotational speed, linear movement of manufacturing tool, base table, or both, and rotation or rotational position of rotary table. As an example, controller may coordinate deposition and/or curing of material in additive manufacturing processes, where manufacturing device is an additive manufacturing device. Persons skilled in the art, upon reading the entirety of this disclosure, will be aware of similar automated control systems usable for various forms manufacturing.

Still referring to FIG. 1, controller may be designed and/or configured to perform any method, method step, or sequence of method steps in any embodiment described in this disclosure, in any order and with any degree of repetition. For instance, controller may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, an object, part, and/or workpiece may be further processed as desired to finish that object, part, and/or workpieces. Examples of further process include but are not limited to: secondary machining, polishing, coating such as powder coating, anodization, silk-screening, and any combination thereof, among others. Fundamentally, there is no limitation on the finishing steps, if any, that may occur for a finishing step.

Still referring to FIG. 1, an apparatus for manufacturing a food container may include a computing device. Apparatus may include a processor. Processor may include, without limitation, any processor described in this disclosure. Processor may be included in computing device. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device.

Still referring to FIG. 1, in some embodiments, an apparatus for manufacturing a food container may include at least a processor and a memory communicatively connected to the at least a processor, the memory containing instructions configuring the at least a processor to perform one or more processes described herein. Computing device may include processor and/or memory. Computing device may be configured to perform one or more processes described herein.

Still referring to FIG. 1, computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

Still referring to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, the depth of a deep drawn container is usually limited to a depth-to-diameter ratio. A typical/historical depth-to-diameter ratio is 0.5 to 1. In some embodiments, single-use container 100 has a depth-to-diameter ratio of at least 0.5, 0.6, 0.7, 0.8, 0.83, 0.9, 1, 1.1, 1.2, 1.3, 1.4, 1.5, or more, wherein the depth is measured from the top of a rim 108 of single-use container 100 to the top of bottom 136 of single-use container 100 and the diameter is measured based on the outside of rim 108. In some embodiments, single-use container 100 has a depth-to-diameter ratio of at least 0.5, 0.6, 0.7, 0.8, 0.83, 0.9, 1, 1.1, 1.2, 1.3, 1.4, 1.5, or more, wherein the depth is measured from the top of a rim 108 of single-use container 100 to the bottom of bottom 136 of single-use container 100 and the diameter is measured based on the outside of rim 108. In some embodiments, single-use container 100 has a depth-to-diameter ratio of at least 0.5, 0.6, 0.7, 0.8, 0.83, 0.9, 1, 1.1, 1.2, 1.3, 1.4, 1.5, or more, wherein the depth is measured from the top of a rim 108 of single-use container 100 to the top of bottom 136 of single-use container 100 and the diameter is measured based on the inside of rim 108. In some embodiments, single-use container 100 has a depth-to-diameter ratio of at least 0.5, 0.6, 0.7, 0.8, 0.83, 0.9, 1, 1.1, 1.2, 1.3, 1.4, 1.5, or more, wherein the depth is measured from the top of a rim 108 of single-use container 100 to the bottom of bottom 136 of single-use container 100 and the diameter is measured based on the inside of rim 108. In some embodiments, single-use container 100 has a depth-to-diameter ratio of at least 0.5, 0.6, 0.7, 0.8, 0.83, 0.9, 1, 1.1, 1.2, 1.3, 1.4, 1.5, or more, with depth measured from flat top surface of rim 108 to a bottom surface along a central axis of single-use container 100, and diameter measured across the exterior of rim 108. In some embodiments, single-use container 100 may enclose a volume of about 57.7 ml. As used herein with respect to volumes, “about” means±2 ml. As examples, single-use container 100 may enclose a volume of at least 55.7 ml, at least 56.7 ml, at most 58.7 ml, and/or at most 59.7 ml. In some embodiments, single-use container 100 may have a diameter of at least 52 mm and/or at most 54 mm. In some embodiments, single-use container 100 may have a diameter of about 54 mm. As used herein with respect to diameters, “about” means±0.3 mm.

Still referring to FIG. 1, in some embodiments, single-use container 100 may be symmetrical about central vertical axis 104. In some embodiments, single-use container 100 may be symmetrical across one or more planes, wherein such planes include central axis 104.

Still referring to FIG. 1, in some embodiments, single-use container 100 may include rim 108. Rim 108 may include a flat top surface. Lid 112 may be affixed to such flat top surface. As used herein, a “flat top surface” of a rim is a surface of a rim which is substantially planar. In some embodiments, a flat top surface of a rim may surround a non-planar portion of single-use container 100. In some embodiments, lid 112 may be affixed to rim 108 using an adhesive. In some embodiments, rim 108 may include a “donut” shape with a diameter of 54±0.3 mm along the outside of rim 108 and/or a diameter of 45±0.3 mm along inside of rim 108. Inside and outside edges of rim 108 may form concentric circles. In some embodiments, an outside of flat top surface may have a diameter of 51±0.3 mm. For example, outside of flat top surface may have a diameter of 51 mm and may have a curved surface such that the outermost diameter is 54 mm. In some embodiments, rim 108 may have a height (as in, a distance from bottom of rim 108 to top of rim 108) of 1.3±0.1 mm. Lid 112 may include a removable material which covers contents of single-use container 100. Lid 112 may include a tab for ease of lid 112 removal.

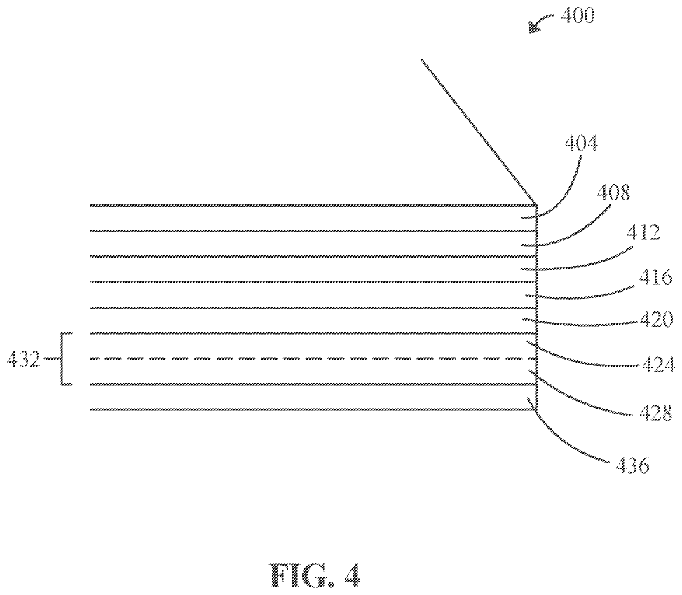

Still referring to FIG. 1, in some embodiments, single-use container 100 may include stacking lip 116 and/or stacking shoulder 120. As used herein, a “stacking lip” is a vertical or approximately vertical circular surface which connects a rim to a stacking shoulder. Stacking lip 116 may include a vertical or approximately vertical circular surface which connects to rim 108 and is positioned below rim 108, as shown in FIG. 1. In some embodiments, stacking lip 116 may have a height of 5.7±0.1 mm. In some embodiments, a height from bottom of stacking lip 116 to top of rim 108 may be 5.8±0.1 mm. As used herein, a “stacking shoulder” is a surface which slopes downward and toward a central vertical axis, and is connects a stacking lip to a sidewall. Stacking shoulder 120 may include an inward sloping surface (such as a surface which slopes downward and toward central vertical axis 104) positioned below stacking lip 116. In some embodiments, inner edge of stacking shoulder 120 may have a diameter of about 43.68 mm. Stacking lip 116 and/or stacking shoulder 120 may aid in stacking multiple instances of empty food containers. For example, a stacking shoulder of a first food container may rest on a top of a stacking lip of a second food container. Stacking of multiple food containers is depicted in FIG. 4. In some embodiments, stacking may allow multiple food containers, such as multiple food containers without lids and/or food contents, to be transported in a space efficient manner. This may be used to, for example, transport food containers to a location where they are to be filled.

Still referring to FIG. 1, in some embodiments, single-use container 100 may include sidewall 124. Sidewall 124 may be in a conical frustum shape such that the top of sidewall 124 is wider than the bottom of sidewall 124. Sidewall 124 may be attached to, and positioned below, stacking shoulder 120. Sidewall 124 may curve inwards toward the bottom of sidewall 124. Sidewall 124 may slope inward according to draft angle 128. As used herein, a “draft angle” is a difference between the slope of a sidewall and downward. In some embodiments, draft angle 128 may be at least 0.2, 0.4, 0.5, 0.6, 0.8, 1, 1.2, 1.4, 1.6, 1.8, 2 degrees, or more. In some embodiments, draft angle 128 may be at most 15, 14, 13, 12, 11, 10, 9, 8, 7, 6, 5.8, 5.6, 5.4, 5.2, 5, 4.8, 4.6, 4.4, 4.2, 4 degrees or less. In some embodiments, draft angle 128 is at least 1 degree and at most 5 degrees. In some embodiments, a draft angle in this range may ease removal of single-use container 100 from a deep drawing device. In some embodiments, a draft angle in this range may enable stacking of multiple instances of single-use container 100.

Still referring to FIG. 1, in some embodiments, single-use container 100 may include one or more ribs 132. Ribs may include straight, aligned indents in sidewall 124. Ribs may aid a user in gripping single-use container 100. In some embodiments, ribs 132 may be vertical. In some embodiments, single-use container 100 may have 24 vertical ribs. In some embodiments, single-use container 100 may include a portion of sidewall 124 above ribs 132 and/or below ribs 132. In some embodiments, ribs 132 do not extend to the top and/or bottom of sidewall 124. In some embodiments, sidewall 124 may include a plurality of ribs, where ribs alternate between extending outward and inward from sidewall 124.

Still referring to FIG. 1, in some embodiments, single-use container 100 may include bottom 136 and/or bottom cutout 140. Bottom 136 may include a flat surface on which single-use container 100 may rest, parallel to the flat top surface as described above, and bottom cutout 140 may include a concave region at the center of bottom 136. In some embodiments, height of bottom cutout 140 is 0.5±0.1 mm. In some embodiments, filling height of single-use container 100 (as in, vertical distance between bottom 136 and rim 108) is 45±0.3 mm. In some embodiments, diameter of bottom cutout 140 is about 27 mm. In some embodiments, diameter of outer edge of bottom 136 is about 32 mm.

Still referring to FIG. 1, in some embodiments, design of single-use container 100 described herein may allow single-use container 100 to withstand typical forces in retail grocery distribution, provide excellent oxygen and moisture barriers for foodstuff preservation, and/or operate correctly within a low pressure beverage making appliance.

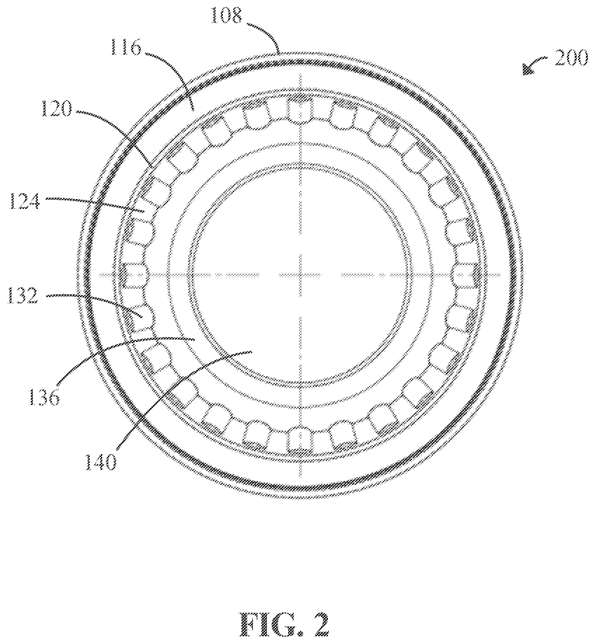

Referring now to FIG. 2, a top view of an exemplary embodiment of single-use container 200 is depicted. As shown in FIG. 2, single-use container 200 may include rim 108, stacking lip 116, stacking shoulder 120, sidewall 124, rib 132, bottom 136, and/or bottom cutout 140. Lid 112 is not depicted in FIG. 2. In some embodiments, single-use container 200 may be symmetrical across one or more planes depicted in FIG. 2.

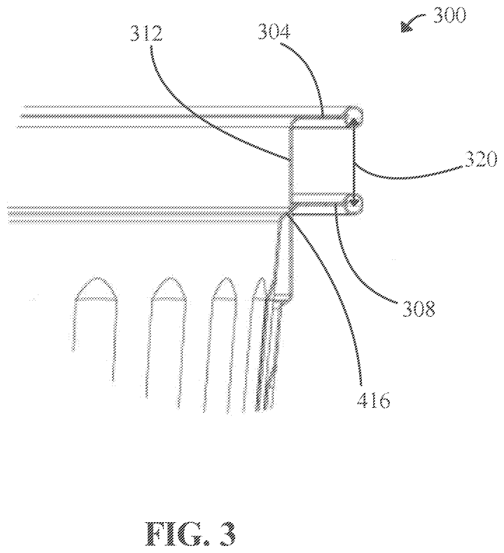

Referring now to FIG. 3, a side view of a portion of a stacking scenario of an exemplary embodiment of system 300 is depicted. In some embodiments, system 300 may include first single-use container 304 and second single-use container 308. First single-use container 304 may include stacking lip 312, which may rest on stacking shoulder 316 of second single-use container 308 when first single-use container 304 is stacked on top of second single-use container 308. In some embodiments, this may result in a stacking distance 320 of about 5.3 mm.

Referring now to FIG. 4, a side view of an exemplary embodiment of multi-layer sheet 400 is depicted. Layers of FIG. 4 are not to scale and are only meant to show an exemplary embodiment of their relative positions. In some embodiments, higher layers in FIG. 4 are positioned closer to outside and/or first side of multi-layer sheet 400, while lower layers in FIG. 4 are positioned closer to inside and/or second side of multi-layer sheet 400. Multi-layer sheet 400 may include first lubricant layer 404, varnish layer 408, printing ink layer 412, primer layer 416, aluminum layer 420, tie layer 424, and/or heat seal layer 428. Tie layer 424 and/or heat seal layer 428 may be components of coextrusion coating 432. Multi-layer sheet 400 may further include second lubricant layer 436. Such layers are described herein with reference to FIG. 1. In some embodiments, composition of multi-layer sheet 400 may enable a manufacturing device to form multi-layer sheet 400 into single-use container 100 as described herein without tearing multi-layer sheet and/or deforming multi-layer sheet outside of shaping multi-layer sheet into a shape of a single-use container described with respect to FIG. 1.

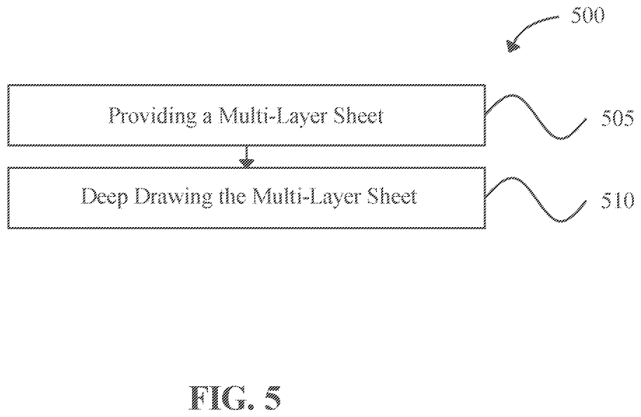

Referring now to FIG. 5, an exemplary embodiment of a method 500 of manufacturing a single-use container is illustrated. Such single-use container may include a single-use coffee pod. One or more steps if method 500 may be implemented, without limitation, as described with reference to other figures. One or more steps of method 500 may be implemented, without limitation, using at least a processor.

Still referring to FIG. 5, in some embodiments, method 500 may include providing a multi-layer sheet 505. A multi-layer sheet may include, from a first side to a second side, a first lubricant layer, an aluminum layer, and a coextrusion coating. In some embodiments, the multi-layer sheet further comprises, between the first lubricant layer and the aluminum layer, a varnish layer, a printing ink layer, and a primer layer. In some embodiments, the varnish layer has a polyurethane base; the printing ink layer has a polyvinyl butyral base; and the primer layer has an acrylate base or a polyester base. In some embodiments, the aluminum layer has a thickness of 90 μm±8%. In some embodiments, the aluminum layer includes 95.5%-98.2% aluminum, ≤0.25% copper, ≤0.70% iron, 0.80%-1.3% magnesium, 1.0%-1.5% manganese, ≤0.3% silicon, and ≤0.25% zinc. In some embodiments, the first lubricant layer has a silicone base. In some embodiments, the multi-layer sheet further comprises a second lubricant layer between the coextrusion coating and second side of the multi-layer sheet.

Still referring to FIG. 5, in some embodiments, method 500 may include deep drawing the multi-layer sheet 510. The multi-layer sheet may be deep drawn to form a single-use coffee pod comprising a rim with a flat top surface, a stacking lip positioned below the rim, an inward tapering sidewall with a draft angle of at least 0.5 degrees and at most 10 degrees positioned below the stacking lip, and a bottom surface such that the first side is on the outside and the second side is on the inside. In some embodiments, the draft angle is at least 1 degree and at most 5 degrees. In some embodiments, the single-use coffee pod has a depth to diameter ratio of more than 0.5:1. In some embodiments, the depth of the depth to diameter ratio is measured from the top of the rim to the bottom surface and the diameter of the depth to diameter ratio is measured based on the outside of the rim. In some embodiments, the coextrusion coating comprises a tie layer and a heat seal layer; and/or the tie layer is between the aluminum layer and the heat seal layer. In some embodiments, the tie layer and the heat seal layer each have a polypropylene base. In some embodiments, the single-use coffee pod has a diameter of at least 52 mm and at most 54 mm.

Still referring to FIG. 5, in some embodiments, method 500 further includes affixing a lid to the flat top surface of the rim, wherein single-use coffee pod encloses a volume of about 57.7 ml.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

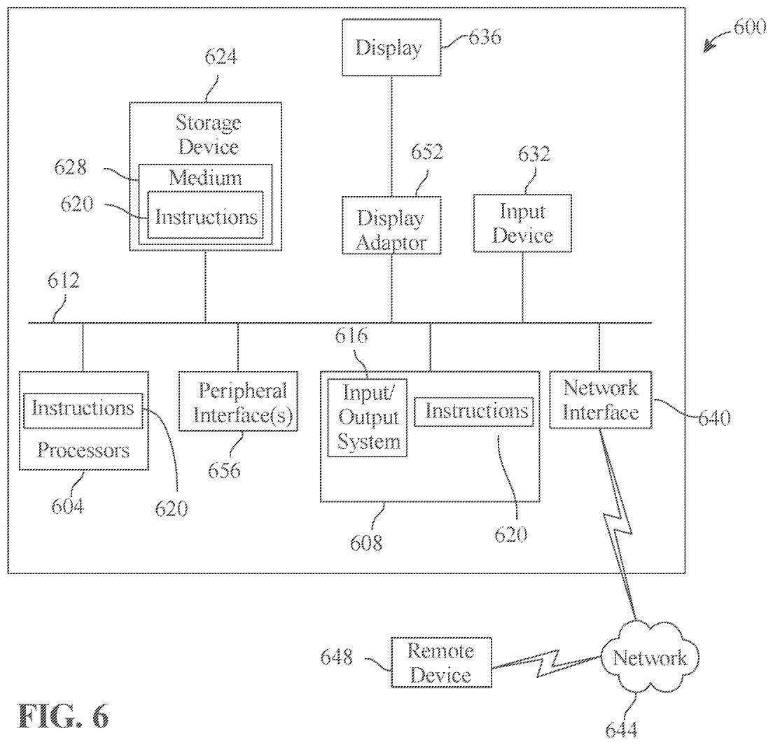

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve devices, methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A single-use container comprising:
a multi-layer sheet comprising:
a rim with a flat top surface;
a stacking lip positioned below the rim;
an inward tapering sidewall with a draft angle of at least 0.5 degrees and at most 10 degrees positioned below the stacking lip; and
a bottom surface comprising a single continuous bottom cutout, wherein the single continuous bottom cutout comprises a concave region at a center of the bottom surface, wherein the single continuous bottom cutout has a diameter of 27 mm and radially extends to an outer periphery of the bottom surface;
wherein the multi-layer sheet comprises, from outside to inside, a first lubricant layer, an aluminum layer, a coextrusion coating, and a printing ink layer, wherein the printing ink layer has a polyvinyl butyral base; and
wherein the single-use container has a depth to diameter ratio of at least 0.5:1, with depth measured from the flat top surface of the rim to the bottom surface along a central axis of the single-use container, and diameter measured across an exterior of the rim.

2. The single-use container of claim 1, wherein:
the coextrusion coating comprises a tie layer and a heat seal layer; and
the tie layer is between the aluminum layer and the heat seal layer.

3. The single-use container of claim 2, wherein the coextrusion coating comprises a polypropylene base.

4. The single-use container of claim 1, wherein the multi-layer sheet further comprises, between the first lubricant layer and the aluminum layer, a varnish layer, and a primer layer.

5. The single-use container of claim 1, wherein the draft angle is at least 1 degree and at most 5 degrees.

6. The single-use container of claim 1, wherein the single-use container has a diameter of at least 52 mm and at most 54 mm.

7. The single-use container of claim 1, wherein the single-use container further comprises a lid affixed to the flat top surface of the rim, wherein the single-use container encloses a volume of 55.7 ml to 59.7 ml.

8. The single-use container of claim 1, wherein the aluminum layer has a thickness of 82.8 μm to 97.2 μm.

9. The single-use container of claim 1, wherein the aluminum layer comprises 95.5%-98.2% aluminum, ≤0.25% copper, ≤0.70% iron, 0.80%-1.3% magnesium, 1.0%-1.5% manganese, ≤0.3% silicon, and ≤0.25% zinc.

10. The single-use container of claim 1, wherein the multi-layer sheet further comprises a second lubricant layer between the coextrusion coating and an interior of the single-use container.

11. A method of manufacturing a single-use container, the method comprising:
providing a multi-layer sheet comprising, from a first side to a second side, a first lubricant layer, an aluminum layer, and a coextrusion coating; and
deep drawing the multi-layer sheet to form a single-use coffee pod comprising a rim with a flat top surface, a stacking lip positioned below the rim, an inward tapering sidewall with a draft angle of at least 0.5 degree and at most 10 degrees positioned below the stacking lip, and a bottom surface such that the first side is on an outside and the second side is on an inside, wherein the bottom surface comprises a single continuous bottom cutout comprising a concave region at a center of the bottom surface, wherein the single continuous bottom cutout has a diameter of 27 mm and radially extends proximate to an outer periphery of the bottom surface;
wherein the single-use container has a depth to diameter ratio of more than 0.5:1, with depth measured from the flat top surface of the rim to the bottom surface along a central axis of the single-use container, and diameter measured across an exterior of the rim.

12. The method of claim 11, wherein:
the coextrusion coating comprises a tie layer and a heat seal layer; and
the tie layer is between the aluminum layer and the heat seal layer.

13. The method of claim 12, wherein the coextrusion coating comprises a polypropylene base.

14. The method of claim 11, wherein the multi-layer sheet further comprises, between the first lubricant layer and the aluminum layer, a varnish layer, a printing ink layer, and a primer layer.

15. The method of claim 11, wherein the draft angle is at least 1 degree and at most 5 degrees.

16. The method of claim 11, wherein the single-use container has a diameter of at least 52 mm and at most 54 mm.

17. The method of claim 11, wherein the method further comprises affixing a lid to the flat top surface of the rim, wherein the single-use container encloses a volume of 55.7 ml to 59.7 ml.

18. The method of claim 11, wherein the aluminum layer has a thickness of 82.8 μm to 97.2 μm.

19. The method of claim 11, wherein the aluminum layer comprises 95.5%-98.2% aluminum, ≤0.25% copper, ≤0.70% iron, 0.80%-1.3% magnesium, 1.0%-1.5% manganese, ≤0.3% silicon, and ≤0.25% zinc.

20. The method of claim 11, wherein the multi-layer sheet further comprises a second lubricant layer between the coextrusion coating and second side of the multi-layer sheet.
